(19) United States
(12) Patent Application Publication
(10) Pub. No.: US 2026/0230642 A1
(43) Pub. Date: Aug. 6, 2026

(54) TECHNIQUES FOR GENERATING ENCODING LADDERS FOR STREAMING LIVE EVENTS

(71) Applicant: NETFLIX, INC., Los Gatos, CA (US)

(72) Inventors: Zhi LI, Mountain View, CA (US); Joe LAWRENCE, Los Gatos, CA (US); Aditya MAVLANKAR, San Francisco, CA (US)

(21) Appl. No.: 19/045,414

(22) Filed: Feb. 4, 2025

(51) Int. Cl. H04N 19/59; H04N 19/154; H04N 21/2187

(52) U.S. Cl. CPC H04N 19/59; H04N 19/154; H04N 21/2187

(57) ABSTRACT

In various embodiments, an encoding ladder application generates encoding ladders that are subsequently used to stream live events. The encoding ladder application generates a set of convex hulls representing encoding tradeoffs between quality and bitrate when encoding a representative video at a set of resolutions;. The encoding ladder application computes a set of bitrate-resolution points to use as fallback bitrate-resolution points using the set of convex hulls and a set of fallback criteria. The encoding ladder application generates an encoding ladder that includes the fallback bitrate-resolution points. Subsequently, an encoding pipeline encodes at least a first portion of a first live video stream based on a first fallback bitrate-resolution point included in the fallback bitrate-resolution points to produce a first segment of a first downloadable.

### BACKGROUND

### Field of the Various Embodiments

The various embodiments relate generally to computer science and to video streaming technology and, more specifically, to techniques for generating encoding ladders for streaming live events.

### Description of the Related Art

A typical media streaming service provides users with access to different video sources that can be viewed on a wide range of different client devices that are capable of streaming video and other media data having a variety of resolutions. In operation, a given client device connects to the media streaming service under a variety of connection conditions and, therefore, can be susceptible to differing network throughputs. In an effort to ensure that a given video source can be streamed to a client device without playback interruptions, a media streaming service normally encodes discrete portions of the video source based on an encoding ladder to generate segments of different downloadables. Each downloadable is typically associated with a different combination of resolution and bitrate (a “bitrate-resolution point”) included in the encoding ladder. As segments of each downloadable are generated, the segments are stored in a content delivery network (CDN) of servers and subsequently streamed to various client devices for playback.

Because a CDN has limited storage resources, generating an encoding ladder for a video source usually involves making tradeoffs between the overall visual quality of a reconstructed version of the video source during playback on a client device and the total size of the downloadables generated using an encoding ladder. In general, an encoding ladder is designed to reduce the total size of the downloadables while ensuring that requisite overall visual quality can be achieved when a video source is encoded at different resolutions and is streamed to different client devices over a network where the network throughput changes over time.

This type of encoding ladder works well when streaming pre-generated downloadables for static video sources, such as movies and other media titles. However, in the context of live events, the downloadables are incrementally generated based on live video feeds in real-time and typically delivered to a large number of client devices simultaneously. As a result, at various points-in-time during a live event, the network and processing resources required to deliver segments to one or more groups of client devices can exceed the available network and/or CDN processing resources. If the available network and/or CDN processing resources are exceeded, then the delivery of requested segments to the client devices can be delayed, which can ultimately result in playback interruptions.

To reduce the likelihood of playback interruptions, a media streaming service can impose a maximum bitrate on one or more subsets of client devices (e.g., all client devices in a specific geographical region) as-needed during a live event. Each client device that is subject to the maximum bitrate is prohibited from requesting segments of downloadables having bitrates that exceed the maximum bitrate. With this type of approach, the network and/or CDN processing resources required to provide requested segments to those subset(s) of client devices can be reduced, thereby decreasing the likelihood of exceeding the available network and/or CDN processing resources.

One drawback of the above approach is that determining a maximum bitrate that effectively reduces the amount of required network and/or CDN processing resources without unacceptably degrading overall visual quality for many of the client devices can be difficult, if not impossible. In that regard, as described previously herein, each encoding ladder usually includes several pre-determined bitrate-resolution points per resolution. Imposing a maximum bitrate across multiple client devices can cause a client device streaming a downloadable having a current resolution and a relatively high overall visual quality to switch to streaming a different downloadable having the same resolution and a substantially lower overall visual quality. For example, imposing a maximum bitrate of 2000 kilobits per second (kbps) could force some client devices to switch from streaming a downloadable having a bitrate of 2500 kbps, a resolution of 1080p, and relatively good visual quality to streaming a downloadable having a bitrate of 750 kbps, a resolution of 1080p, and relatively poor visual quality.

As the foregoing illustrates, what is needed in the art are more effective techniques for streaming live events.

### SUMMARY

One embodiment sets forth a computer-implemented method for generating encoding ladders that are subsequently used to stream live events. The method includes generating a set of convex hulls representing encoding tradeoffs between quality and bitrate when encoding a representative video at a set of resolutions; computing a first set of bitrate-resolution points to use as fallback bitrate-resolution points using the set of convex hulls and a set of fallback criteria; generating an encoding ladder that includes the fallback bitrate-resolution points; and encoding at least a first portion of a first live video stream based on a first fallback bitrate-resolution point included in the fallback bitrate-resolution points to produce a first segment of a first downloadable.

At least one technical advantage of the disclosed techniques relative to the prior art is that, with the disclosed techniques, any number of fallback resolution-bitrate points can be identified and included in a given encoding ladder when generating the encoding ladder, in the first instance, prior to a live event. With this type of modified encoding ladder, imposing a maximum bitrate during the live event that is no less than the bitrate specified in a given fallback resolution-bitrate point ensures that client devices capable of streaming the live event at the resolution specified in the fallback resolution-bitrate point can achieve the overall visual quality associated with the fallback resolution-bitrate point. Thus, the disclosed techniques enable certain client devices to operate at fallback resolution-bitrate points while streaming a live event, which provides opportunities to adaptively reduce the amount of network and/or CDN processing resources required when streaming the live event without unacceptably degrading overall visual quality for those client devices. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual illustration of a system configured to implement one or more aspects of the various embodiments

FIG. 2 is a more detailed illustration of the ladder generator of FIG. 1, according to various embodiments;

FIG. 3 is an exemplar illustration of multiple different convex hull curves corresponding to the convex hull set of FIG. 2, according to various embodiments;

FIG. 4 is an exemplar illustration of rung data, an encoding ladder, and a fallback bitrate list generated by the ladder generator of FIG. 2, according to various embodiments; and

FIG. 5 is a flow diagram of method steps for generating an encoding ladder and fallback bitrate list for use when streaming one or more live events, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

In an effort to ensure that a given live event can be streamed to a client device without playback interruptions, under a wide range of network bandwidths, a media streaming service typically encodes a live video feed in real-time based on an encoding ladder to incrementally generate multiple downloadables. Each downloadable is associated with a different combination of resolution and bitrate. As segments of each downloadable are generated, the segments are stored in a content delivery network (CDN) of servers and subsequently transmitted on-demand to various client devices for playback.

To further reduce the likelihood of playback interruptions, the media streaming service can impose a maximum bitrate on one or more subsets of client devices (e.g., all client devices in a specific geographical region) as-needed during a live event. Each client device that is subject to the maximum bitrate is prohibited from requesting segments of downloadables having bitrates that exceed the maximum bitrate. By reducing the network and/or CDN processing resources required to provide requested segments to those subset(s) of client devices, the likelihood of exceeding the available network and/or CDN processing resources and therefore the likelihood of playback interruptions can be reduced.

One drawback of the above approach is that because the CDN has limited storage resources, the number of bitrate-resolution points and therefore the number of different downloadables is usually relatively small. And with a typical encoding ladder, determining a maximum bitrate that effectively reduces the amount of required network and/or CDN processing resources without unacceptably and/or unnecessarily degrading overall visual quality for many of the client devices can be difficult, if not impossible. For example, imposing a maximum bitrate of 2000 kbps could force some client devices to switch from streaming a downloadable having a bitrate of 2500 kbps, a resolution of 1080p, and relatively good visual quality to streaming a downloadable having a bitrate of 750 kbps, a resolution of 1080p, and relatively poor visual quality.

With the disclosed techniques, however, an encoding ladder application generates an encoding ladder that includes one or more fallback bitrate-resolution points. As used herein, a “fallback bitrate-resolution point” provides a visually effective fallback for one or more bitrate-resolution points included in the encoding ladder that are prohibited when a corresponding maximum bitrate is imposed. The encoding ladder application determines fallback bitrate-resolution points based on a shadow point prohibition, a fallback per resolution requirement, a quality saturation fit preference, or a bitrate reduction preference.

The shadow point prohibition prohibits the use of a sub-optimal bitrate-resolution point as a fallback bitrate-resolution point. The fallback per resolution requirement requires a different fallback bitrate-resolution point for each of any number of specified resolutions. The quality saturation fit preference is a preference to select a fallback bitrate-resolution point for a given resolution that has an overall visual quality score similar to the visual quality saturation of a next lower resolution. The visual quality saturation of a resolution is the visual quality of a point at which increasing the number of bits used to encode a video at the resolution does not perceptibly increase the visual quality of a corresponding reconstructed video. The bitrate reduction preference is a preference to select a fallback bitrate-resolution points that achieves a bitrate reduction that is within a specified range (e.g., 40%-60%) relative to another fallback bitrate-resolution point,

At least one technical advantage of the disclosed techniques relative to the prior art is that imposing a maximum bitrate during a live event that is no less that the bitrate specified in a given fallback resolution-bitrate point can effectively reduce the amount of required network and/or CDN processing resources without unacceptably and/or unnecessarily degrading overall visual quality for impacted client devices. Thus, the disclosed techniques provide opportunities to adaptively and visually effectively reduce the likelihood of playback interruptions when streaming the live event. These technical advantages provide one or more technological improvements over prior art approaches.

### System Overview

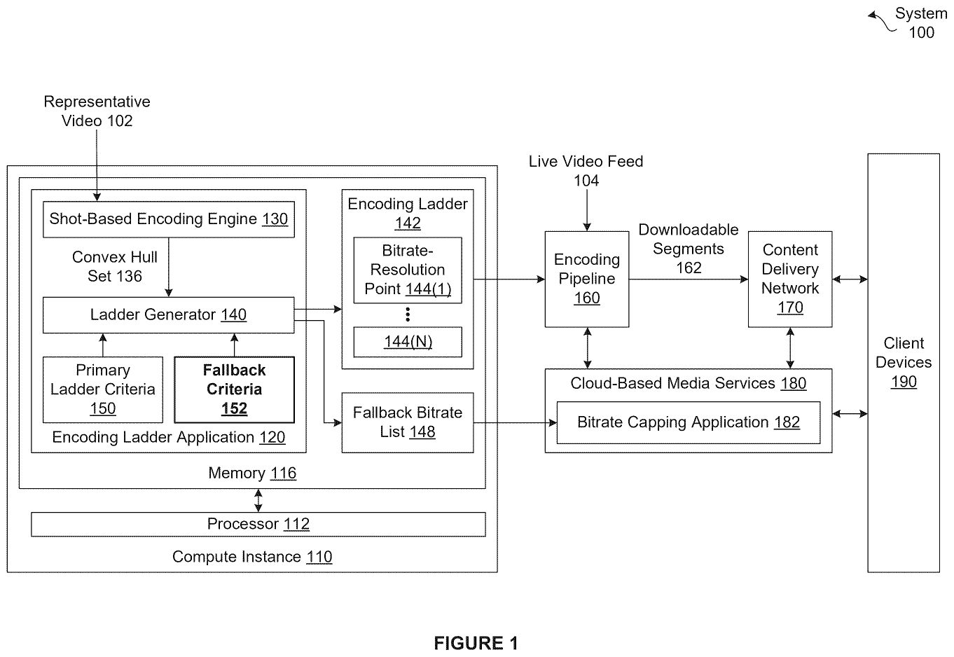

FIG. 1 is a conceptual illustration of a system 100 configured to implement one or more aspects of the various embodiments. For explanatory purposes, multiple instances or versions of like objects are denoted with reference numbers identifying the object and parenthetical alphanumeric character(s) identifying the instance where needed. As shown, in some embodiments, the system 100 includes, without limitation, a compute instance 110, an encoding pipeline 160, a content delivery network (CDN) 170, client devices 190, and cloud-based media services 180.

In some other embodiments, the system 100 can omit the encoding pipeline 160, the CDN 170, the client devices 190, the cloud-based media service 180, or any combination thereof. In the same or other embodiments, the system 100 can include, without limitation, any number and/or types of other computer instances, any number and/or types of other CDNs, any number and/or types of other encoding pipelines, any number and/or types of other cloud-based media services, or any combination thereof.

The components of the system 100 can be distributed across any number of shared geographic locations and/or any number of different geographic locations and/or implemented in one or more cloud computing environments (e.g, encapsulated shared resources, software, data, etc.) in any combination. In some embodiments, the compute instance 110 and/or zero or more other compute instances can be implemented in a cloud computing environment, implemented as part of any other distributed computing environment, or implemented in a stand-alone fashion.

As shown, the compute instance 110 includes, without limitation, a processor 112 and a memory 116. In some embodiments, each of any number of other compute instances can include any number of other processors and any number of other memories in any combination. In particular, the compute instance 110 and/or one or more other compute instances can provide a multiprocessing environment in any technically feasible fashion.

The processor 112 can be any instruction execution system, apparatus, or device capable of executing instructions. For example, the processor 112 could comprise a central processing unit, a graphics processing unit, a controller, a micro-controller, a state machine, or any combination thereof. The memory 116 stores content, such as software applications and data, for use by the processor 112 of the compute instance 110. The memory 116 can be one or more of a readily available memory, such as random access memory, read only memory, floppy disk, hard disk, or any other form of digital storage, local or remote.

In some embodiments, a storage (not shown) can supplement or replace the memory 116. The storage can include any number and type of external memories that are accessible to the processor 112. For example, and without limitation, the storage can include a Secure Digital Card, an external Flash memory, a portable compact disc read-only memory, an optical storage device, a magnetic storage device, or any suitable combination of the foregoing.

In general, each of the compute instance 110 and any number (including none) of other compute instances is configured to implement one or more software applications. For explanatory purposes only, each software application is described as residing in the memory 116 of the compute instance 110 and executing on the processor 112 of the compute instance 110. However, in some other embodiments, the functionality of each software application can be distributed across any number of other software applications that reside in any number of instances of the memory 116 of any number of compute instances 110 and execute on any number of instances of the processor 112 of any number of compute instances 110 in any combination. Further, the functionality of any number of software applications can be consolidated into a single software application.

In particular, in some embodiments, the compute instance 110 is configured to generate, without limitation, a different encoding ladder for each of any number of representative videos, where each representative video is a static video source. Each encoding ladder is subsequently used by the encoding pipeline 160 to incrementally generate segments of one or more downloadables based on one or more live video feeds associated with any number of live events. Segments of downloadables are also referred to herein as “downloadable segments,” Each downloadable segment is transmitted to any number of the client devices 190 via the CDN 170 on-demand.

For explanatory purposes, the functionality of the system 100 is described herein in the context of generating an encoding ladder 142 based on a representative video 102, encoding a live video feed 104 using the encoding ladder 142 to generate downloadables segments 162, and delivering the downloadable segments 162 to any number of the client device 190 via the CDN 170 on-demand.

As shown, the compute instance 110 generates the encoding ladder 142 based on the representative video 102. In some embodiments, the encoding ladder 142 includes, without limitation, a bitrate-resolution point 144(1)—a bitrate-resolution point 144(N), where N can be any positive integer. Each of the bitrate-resolution point 144(1)—the bitrate-resolution point 144(N) includes a different combination of bitrate and resolution and corresponds to a different rung of the encoding ladder 142. Accordingly, each of N rungs of the encoding ladder 142 specifies a different combination of bitrate and resolution. For explanatory purposes only, the bitrate-resolution point 144(1)—the bitrate-resolution point 144(N) are also referred to herein individually as “the bitrate-resolution point 144” and collectively as “the bitrate-resolution points 144.”

The representative video 102 is a static video source that includes, without limitation, any amount and/or types of video content. Some examples of static video sources are any portion (including all) of feature-length films, episodes of prerecorded television programs, music videos, and podcasts, to name a few. In some embodiments, the representative video 102 has any number of characteristics (e.g., genre, visual complexity) that are similar to the live video feed 104 associated with a live event that has not yet occurred. Some examples of live events are a live sporting event, a live television show, a live performance, a live speech, and a live meeting. Each live event can be associated with any number of different live media feeds, where each live media feed is associated with a different source (e.g., a different camera).

As shown, the compute instance 110 is configured to transmit the encoding ladder 142 to an encoding pipeline 160. Subsequently, throughout the live event, the encoding pipeline 160 incrementally encodes the live video feed 104 across the bitrate-resolution points 144 to incrementally generate the downloadable segments 162. The downloadable segments 162 include segments of N different downloadables, where each downloadable corresponds to a different combination of bitrate and resolution. As the encoding pipeline 160 generates each of the downloadable segments 162, the encoding pipeline 160 transmits the downloadable segment to the CDN 170.

The CDN 170 includes, without limitation, an origin server (not shown) and any number and/or types of caching servers (not shown) that are each capable of selectively caching segments of downloadables. The origin server stores the downloadable segments 162 in one or more associated memories (not shown) for subsequent on-demand delivery to the client devices 190 via the caching servers.

Each of the client devices 190 can be any type of device that is capable of communicating with the CDN 170 to stream live events. More specifically, each of the client devices 190 is capable of requesting, decoding, and playing back one or more of the downloadable segments 162 in any technically feasible fashion. For instance, in some embodiments, each of the client device 190 requests any number of the downloadable segments 162 from a proximate caching server in the CDN 170 based on the encoding ladder 142 and an available network throughput to affect streaming of the live event. Some examples of a client device include, without limitation, a smart television, a game console, a desktop computer, a laptop, a smartphone, and a tablet.

Any number of the client device 190 (including none) can be resolution-constrained client devices. As used herein, a “resolution-constrained client device” cannot successfully request and/or play back a subset of the downloadable segments 162 that correspond to a subset of the resolutions represented in the encoding ladder 142. For example, one or more of the client devices 190 may not be capable of displaying a subset of the downloadable segments 162 that are associated with a resolution greater than 1080p.

The cloud-based media services 180 includes, without limitation, microservices, databases, and storage for activities and content associated with the streaming media service that are allocated to none of the encoding pipeline 160, the CDN 170, or the client devices 190. Some examples of functionality that the cloud-based media services 180 can provide include, without limitation, login and billing, personalized live event and media title recommendations, video transcoding, server and connection health monitoring, and client-specific CDN guidance.

As described previously herein, downloadables associated with live events are typically delivered to a large number of client devices simultaneously. If the available network and/or CDN processing resources are exceeded, then the delivery of requested segments to the client devices can be delayed, which can ultimately result in playback interruptions. To reduce the likelihood of playback interruptions, conventional cloud-based media services can impose a maximum bitrate on one or more subsets of client devices (e.g., all client devices in a specific geographical region) as-needed during the live event. Each client device that is subject to the maximum bitrate is prohibited from requesting segments of downloadables having bitrates that exceed the maximum bitrate. One drawback of the above approach is that determining a bitrate that effectively reduces the amount of required network and/or CDN processing resources without unacceptably degrading overall visual quality for many of the client devices can be difficult, if not impossible, when encoding live video feeds using conventional encoding ladders.

### Implementing Fallback Bitrate-Resolution Points

To address the above problem, the compute instance 110 includes, without limitation, an encoding ladder application 120 that identifies and includes in the encoding ladder 142 one or more fallback bitrate-resolution points when generating the encoding ladder 142. As used herein, a “fallback bitrate-resolution point” is a bitrate-resolution point included in an encoding ladder that is intended as a fallback to one or more bitrate-resolution points included in the encoding ladder that are prohibited when a corresponding maximum bitrate is imposed. Imposing a maximum bitrate during the live event that is no less that the bitrate specified in a given fallback resolution-bitrate point ensures that any of the client devices capable 190 of streaming the live event at the resolution specified in the fallback resolution-bitrate point can achieve the overall visual quality associated with the fallback resolution-bitrate point.

Additionally, in some embodiments, the encoding ladder application 120 generates a fallback bitrate list 148 that specifies a different bitrate for each of the fallback bitrate-resolution points. The encoding ladder application 120 transmits the fallback bitrate list 148 to the cloud-based media services 180 prior to the live event. As described in greater detail below, the cloud-based media services 180 can use the fallback bitrate list 148 to impose any number of maximum bitrates on any number of different subsets of the client devices 190. In this fashion, the cloud-based media services 180 can limit the downloadable segments 162 that are transmitted to the client devices 190 based on the fallback bitrate list 148 to reduce the likelihood of playback interruptions during the live event.

The encoding ladder application 120 resides in the memory 116 of the compute instance 110 and executes on the processor 112 of the compute instance 110. As shown, the encoding ladder application 120 includes, without limitation, a shot-based encoding engine 130, a ladder generator 140, primary ladder criteria 150, and fallback criteria 152.

The shot-based encoding engine 130 partitions the representative video 102 into shots (not shown). Each shot includes a sequence of frames that usually have similar spatial-temporal properties and run for an uninterrupted period of time. In some embodiments, each shot is captured continuously from a single camera or virtual representation of a camera (e.g., in the case of computer animated videos). Together, the shots span the length of the representative video 102 in a contiguous, non-overlapping fashion.

The shot-based encoding engine 130 downscales each of the shots to multiple different resolutions to generate lower-resolution shots. The shot-based encoding engine 130 encodes each of the shots and each of the lower-resolution shots across different sets of one or more values for a set of one or more encoding parameters to generate encoded shots having different combinations of resolutions and bitrates. The shot-based encoding engine 130 computes a bitrate and a quality score for each encoded shot.

As used herein, the bitrate of an encoded sequence of frames (e.g., an encoded shot or an encoded video) refers to an average bitrate across the encoded sequence of frames. The quality score of an encoded sequence of frames refers to a quality score of a reconstructed sequence of frames derived from the encoded sequence of frames. And the quality score of a reconstructed sequence of frames refers to an average estimated visual quality level across the reconstructed sequence of frames.

A quality score can be a value for any type of metric that correlates to visual quality in any technically feasible fashion. In some embodiments, each quality score is a value for a visual quality metric. Some examples of visual quality metrics include, without limitation, a peak signal-to-noise-ratio (PSNR), and a video multimethod assessment fusion (VMAF) metric. The VMAF metric estimates human-perceived video quality of reconstructed video content (e.g., the reconstructed shots, reconstructed videos, etc.). As used herein, the VMAF metric estimates perceptual video quality.

For each resolution, the shot-based encoding engine 130 generates a convex hull (not shown in FIG. 1) of bitrate-quality points based on the encoded shots having that resolution. Each convex hull optimizes tradeoffs between bitrate and quality score for the associated resolution. Each of the bitrate-quality points specifies an encoded video, the bitrate of the encoded video, the resolution of the encoded video, and a quality score for the encoded video. Notably, the resolution across each of the encoded videos is constant, but the bitrate and quality score can vary.

To generate the convex hull for a given resolution, the shot-based encoding engine 130 computes the bitrate and quality score for each encoded shot having the resolution. Subsequently, the shot-based encoding engine 130 performs any number and/or types of operations based on the bitrates and the quality scores to aggregate the encoded shots into encoded videos. For the resolution, each of the encoded videos is associated with the highest visual quality level for a different bitrate. The shot-based encoding engine 130 generates a different bitrate-quality point for each of the resulting encoded videos to determine the convex hull for the resolution. More specifically, the shot-based encoding engine 130 aggregates the bitrate-quality points corresponding to the resolution to generate the convex hull for the resolution.

The shot-based encoding engine 130 generates a convex hull set 136 that includes, without limitation, the convex hulls for the different resolutions. Accordingly, the convex hull set 136 includes a union of the bitrate-quality points included in the convex hulls for the different resolutions. The shot-based encoding engine 130 optionally normalizes the bitrates and the quality scores specified in the bitrate-quality points across all convex hulls to the same range in any technically feasible fashion. The convex hull set 136 facilitates the generation of the encoding ladder 142.

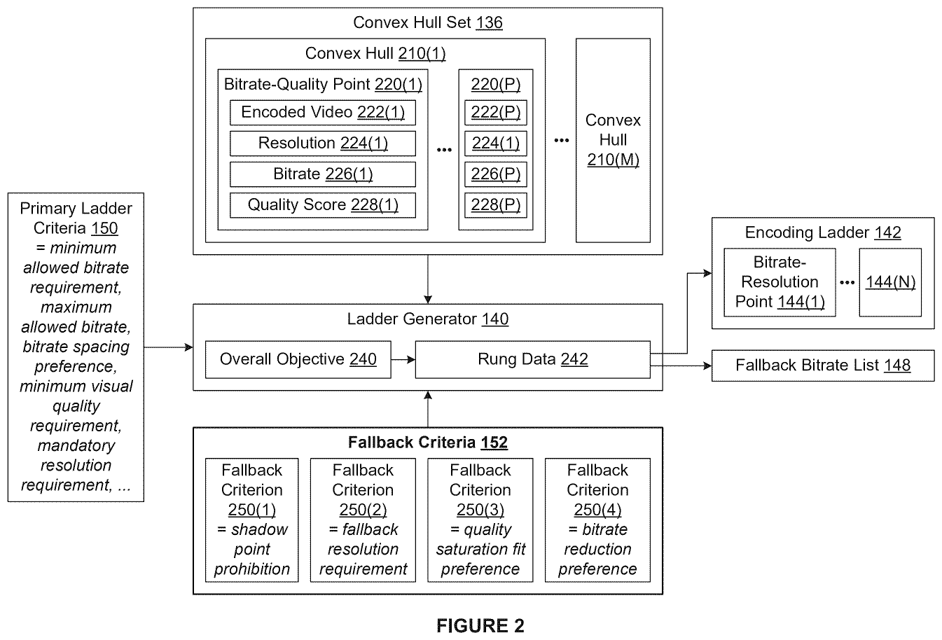

As shown, in some embodiments, the ladder generator 140 generates the encoding ladder 142 and the fallback bitrate list 148 based on the convex hull set 136, the primary ladder criteria 150, and the fallback criteria 152. As described in greater detail below in conjunction with FIG. 2, the ladder generator 140 computes a set of bitrate-resolution points based on an overall objective (not shown in FIG. 1) while accounting for the primary ladder criteria 150, and the fallback criteria 152. Each bitrate-resolution point included in the set of bitrate-resolution points corresponds to a different bitrate-quality point included in the convex hull set 136.

Importantly, the ladder generator 140 computes one more of the bitrate-resolution points included in the set of bitrate-resolution points to use as fallback bitrate-resolution points using the convex hull set 136, the primary ladder criteria 150, and the fallback criteria 152. A bitrate-resolution point that the ladder generator 140 designates for use as a fallback bitrate-resolution point is also referred to herein as a “fallback bitrate resolution point.” The ladder generator 140 computes the remaining bitrate-resolution points included in the set of bitrate-resolution points based on the convex hull set 136 and the primary ladder criteria 150.

In some embodiments, the overall objective is to reduce the total size of downloadables associated with the representative video 102 when generated based on the encoding ladder 142 while ensuring that requisite visual quality can be achieved. The primary ladder criteria 150 ensure the validity of the encoding ladder 142 and capture operational restrictions and/or preferences that are associated with capabilities of client devices, network capacity, a CDN, human perception of visual quality, etc. For explanatory purposes, the primary ladder criteria 150 are also referred to herein collectively as a “set of primary ladder criteria” and individually as a “ladder criterion.” As described in greater detail below in conjunction with FIG. 2, in some embodiments, primary ladder criteria 150 include a minimum allowed bitrate requirement, a maximum allowed bitrate requirement, a target bitrate spacing preference, a minimum visual quality requirement, a mandatory resolution requirement, any number and/or types of other criteria, or any combination thereof.

The fallback criteria 152 ensure that the encoding ladder 142 includes one or more effective fallback bitrate-resolution points. The fallback criteria 152 are also referred to herein collectively as a “set of fallback criteria” and individually as a “fallback criterion.” As described in greater detail below in conjunction with FIG. 2, in some embodiments, the fallback criteria 152 include at least one of a shadow point prohibition, a fallback per resolution requirement, a quality saturation fit preference, or a bitrate reduction preference.

In some embodiments the ladder generator 140 generates the fallback bitrate list 148 based on the fallback bitrate-resolution points. The fallback bitrate list 148 includes, without limitation, a different bitrate for each of the fallback bitrate-resolution points. More specifically, in some embodiments, the fallback bitrate list 148 includes the bitrates of the fallback bitrate-resolution points. In some other embodiments, the fallback bitrate list 148 includes bitrates that are slightly higher than the bitrates of the fallback bitrate-resolution points

As shown, the ladder generator 140 transmits the encoding ladder 142 to the encoding pipeline 160 and the fallback bitrate list 148 to the cloud based media services 180. The ladder generator 140, the primary ladder criteria 150, and the fallback criteria 152 are described in greater detail below in conjunction with FIG. 2.

As described previously herein, throughout the live event, the encoding pipeline 160 encodes the live video feed 104 based on the encoding ladder 142 to generate the downloadable segments 162. Throughout the live event, the encoding pipeline 160 transmits the downloadable segments 162 to the CDN 170 for on-demand delivery to the client devices 190.

In some other embodiments the encoding pipeline 160 also encodes any number of other live video feeds associated with the live event and/or any number of other live video feeds associated with any number of other live events based on the encoding ladder 142 to generate any number of segments associated with any number of other downloadables. The encoding pipeline 160 also transmits the segments of the downloadables to the CDN 170 for on-demand delivery to the client devices 190.

As shown, in some embodiments, the cloud-based media services 180 includes, without limitation a bitrate capping application 182. During the live event, the bitrate capping application 182 can determine that a maximum bitrate should be imposed on any number (including none) of subsets of the client devices 190 based on any number and/or types of measurements associated with the amount of CDN processing and/or network resources present during any intervals of time.

For instance, in some embodiments, the bitrate capping application 182 can determine that a maximum bitrate should be imposed on a subset of the client devices 190 that are connected to a given network based on an average amount of network traffic present on the given network since the beginning of the live event.

Upon determining that a maximum bitrate should be imposed on a subset of the client devices 190, the bitrate capping application 182 determines a maximum bitrate based on the fallback bitrate list 148. The bitrate capping application 182 can determine a maximum bitrate based on any number and/or types of criteria. For instance, in some embodiments, the bitrate capping application 182 sets a maximum bitrate equal to one of the bitrates included in the fallback bitrate list 148 based on a target level of bitrate reduction and/or a current maximum bitrate associated with the subset of the client devices 190. The bitrate capping application 182 then conveys the maximum bitrate to the subset of the client devices 190.

Please note that the techniques described herein are illustrative rather than restrictive and can be altered without departing from the broader spirit and scope of the invention. Many modifications and variations on the functionality provided by the encoding ladder application 120, the shot-based encoding engine 130, the ladder generator 140, the encoding pipeline 160, the CDN 170, the cloud-based media services 180, the bitrate capping application 182, and the client devices 190 will be apparent to those of ordinary skill in the art without departing from the scope and spirit of the described embodiments.

For instance, in some embodiments, the shot-based encoding engine 130, can be configured to identify and operate on sets of frames for which a consistency metric lies within a specified range instead of shots. Each set of frames is also referred to herein as a “subsequence.” In a complementary fashion, an encoded set of frames is also referred to herein as “an encoded subsequence.”

It will be apparent to one skilled in the art that the inventive concepts may be practiced without one or more of these specific details. For instance, in some alternate embodiments, the ladder generator 140 does not generate the fallback bitrate list 148. In the same or other embodiments, the ladder generator 140 can convey any amount and/or types of data associated with fallback resolution-points included in the encoding ladder 142 to any number and/or types of applications in any technically feasible fashion.

The storage, organization, amount, and/or types of data described herein are illustrative rather than restrictive and can be altered without departing from the broader spirit and scope of the embodiments. In that regard, many modifications and variations on the representative video 102, the primary ladder criteria 150 the fallback criteria 152, the encoding ladder 142, the fallback bitrate list 148, the live video feed 104, and the downloadable segments 162 as described herein will be apparent to those of ordinary skill in the art without departing from the scope and spirit of the described embodiments.

It will be appreciated that the system 100 shown herein is illustrative and that variations and modifications are possible. For example, the functionality provided by the encoding ladder application 120, the shot-based encoding engine 130, the ladder generator 140, the encoding pipeline 160, the CDN 170, the cloud-based media services 180, the bitrate capping application 182, and the client devices 190 as described herein can be integrated into or distributed across any number of software applications (including one), hardware devices (e.g., a hardware-based encoder), and any number of components of the system 100. Further, the connection topology between the various units in FIG. 1 can be modified as desired.

### Generating Encoding Ladders That Include Fallback Bitrate-Resolution Points

FIG. 2 is a more detailed illustration of the ladder generator 140 of FIG. 1, according to various embodiments. As described previously herein in conjunction with FIG. 1, the ladder generator 140 generates the encoding ladder 142 and the fallback bitrate list 148 based on the convex hull set 136, the primary ladder criteria 150, and the fallback criteria 152 in order to achieve an overall objective 240.

As shown, the convex hull set 136 includes, without limitation, a convex hull 210(1)—a convex hull 210(M), where M can be any positive integer. For explanatory purposes only, the convex hull 210(1)—the convex hull 210(M) are also referred to herein individually as “the convex hull 210” and “the convex hull 210 of bitrate-quality points” and collectively as “the convex hulls 210” and “the convex hulls 210 of bitrate-quality points.” Importantly, each of the convex hulls 210 is associated with a different resolution.

As shown, the convex hull 210(1) includes, without limitation, a bitrate-quality point 220(1)—a bitrate-quality point 220(P), where P can be any positive integer. Although not explicitly shown, each of the convex hull 210(2)—the convex hull 210(M) includes, without limitation, any number of bitrate-quality points. The number of bitrate-quality points in each of the convex hulls 210 can vary.

In some embodiments, each bitrate-quality point includes, without limitation, a different encoded video, the resolution of the encoded video, the bitrate of the encoded video, and a quality score associated with the encoded video. Each of the encoded videos is a sequence of encoded shots corresponding to the sequence of shots included in the representative video 102, where the bitrates of and the quality scores associated with the encoded shots can vary, but the resolutions of the encoded shots do not vary. For each convex hull 210, the encoded videos included in the convex hull 210 are associated with the same resolution as the convex hull 210. Accordingly, each of the bitrate-quality points in the convex hull 210 includes the resolution associated with the convex hull 210.

For instance, the convex hull 210(1) is associated with a resolution 224(1). As shown, the bitrate-quality point 220(1) includes, without limitation, an encoded video 222(1), the resolution 224(1), a bitrate 226(1), and a quality score 228(1). The bitrate-quality point 220(P) includes, without limitation, an encoded video 222(P), the resolution 224(1), a bitrate 226(P), and a quality score 228(P).

As described previously herein in conjunction with FIG. 1, the primary ladder criteria 150 ensure the validity of the encoding ladder 142 and capture operational restrictions and/or preferences that are associated with capabilities of client devices, network capacity, a CDN, human perception of visual quality, etc. As shown (in italics), in some embodiments the primary ladder criteria 150 include a minimum allowed bitrate requirement, a maximum allowed bitrate requirement, a target bitrate spacing preference, a minimum visual quality requirement, a mandatory resolution requirement, any number and/or types of other criteria, or any combination thereof.

A minimum allowed bitrate requirement specifies a minimum allowed bitrate and stipulates that none of the bitrates represented by the encoding ladder 142 is to be lower than the lowest allowed bitrate. A maximum allowed bitrate requirement specifies a lowest allowed bitrate and stipulates that none of the bitrates represented by the encoding ladder 142 is to be lower than the lowest allowed bitrate. A bitrate spacing preference specifies a target bitrate spacing for the bitrates represented by the encoding ladder 142. A minimum visual quality requirement specifies a minimum quality score and stipulates that none of the quality scores associated with the bitrate-resolution points included in the encoding ladder 142 is less than the minimum quality score. A mandatory resolution requirement specifies one or more mandatory resolutions and stipulates that for each mandatory resolution, the resolution of at least one of the bitrate-resolution points included in the encoding ladder 142 is equal to the mandatory resolution.

Notably, in accordance with any number of the primary ladder criteria 150 (e.g., a mandatory resolution requirement), the ladder generator 140 can select one or more sub-optimal bitrate-resolution points for inclusion in the encoding ladder 142 to support resolution-constrained client devices. The quality score of a bitrate-quality point corresponding to a sub-optimal bitrate-resolution point is lower than the quality score of at least one other bitrate-quality score included in the convex hull set 136 that has the same bitrate as the sub-optimal bitrate-resolution point but a different resolution. A sub-optimal bitrate-resolution point that is included in the encoding ladder 142 is also referred to herein as a “shadow bitrate-resolution point.”

As described previously herein in conjunction with FIG. 1, the fallback criteria 152 ensure that the encoding ladder 142 includes one or more effective fallback bitrate-resolution points. As shown, in some embodiments, the fallback criteria 152 include, without limitation, a fallback criterion 250(1)—a fallback criterion 250(4). In some other embodiments, the number and/or types of fallback criteria included in the fallback criteria 152 can vary.

As shown, in some embodiments, the fallback criterion 250(1) is a shadow point prohibition. The shadow point prohibition prohibits the use of a sub-optimal bitrate-resolution point (e.g., a shadow bitrate-resolution point) as a fallback bitrate-resolution point.

As shown, in some embodiments, the fallback criterion 250(2) is a fallback per resolution requirement, The fallback resolution requirement specifies that the encoding ladder is to include at least one fallback resolution-bitrate point for each resolution included in a subset of the set of resolutions used to generate the convex hull set 136.

As shown, in some embodiments, the fallback criterion 250(3) is a quality saturation fit preference. The quality saturation fit preference is an optionally weighted preference that is applied when selecting one or more fallback points for a non-lowest resolution to select a fallback bitrate-resolution point corresponding to a quality score that is higher and relatively close to the saturation quality score (not shown) of the next lower resolution. A saturation quality score for a resolution is the quality score at which increasing the number of bits used to encode the representative video 102 at the resolution does not perceptibly increase the visual quality of the corresponding

### Reconstructed Video.

The ladder generator 140 computes the saturation quality score for a given resolution based on the convex hull 210 associated with the given resolution. Accordingly, in some embodiments, to compute a fallback bitrate-resolution point for a non-lowest resolution, the ladder generator 140 computes a saturation quality score for the next lower resolution and then computes the fallback bitrate-resolution points based on the saturation quality score, the convex hull 210 associated with the resolution, and the fallback criterion 250(3).

The ladder generator 140 can compute the saturation quality score for a resolution based on the convex hull for the resolution in any technically feasible fashion. For instance, in some embodiments, to determine the saturation quality score for a resolution denoted R (e.g., 2160p, 1080p), the ladder generator 140 evaluates the convex hull 210 associated with the resolution R to determine a saturation point at which the slope of a corresponding convex hull curve (not shown in FIG. 2) decreases below a saturation slope (not shown). The ladder generator 140 then sets the saturation quality score for the resolution R equal to the quality score of the saturation point.

As shown, in some embodiments, the fallback criterion 250(4) is a bitrate reduction preference. The bitrate reduction preference is an optionally weighted preference to select fallback bitrate-resolution points that achieve a bitrate reduction that is within a specified range (e.g., 40%-60%) of either another fallback bitrate-resolution point or a highest bitrate represented by the encoding ladder 142. As used herein, the highest bitrate that is represented by the encoding ladder 142 is the highest of the bitrates specified by the bitrate-resolution points included in the encoding ladder 142. In accordance with the fallback criterion 250(4), in some embodiments, the ladder generator 140 can determine at least one fallback bitrate-resolution point based on a bitrate associated with a different fallback bitrate-resolution point and the specified bitrate reduction range.

As persons skilled in the art will recognize, weights can be selected to quantify any number and/or types of tradeoffs between any number of the primary ladder criteria 150 and/or any number of the fallback criteria 152. For instance, in some embodiments, weights are used to quantify a tradeoff between the fallback criterion 250(3) and the fallback criterion 250(4). Further, any number (including none) of the primary ladder criteria 150 and any number (including none) of the fallback criteria 152 can be parameterized.

As shown, in some embodiments, the ladder generator 140 includes, without limitation, the overall objective 240, and rung data 242. The overall objective 240 quantifies one or more tradeoffs between the overall visual quality of a reconstructed version of the representative video 102 during playback on a client device and the total size of the downloadables generated for the representative video 102 using an encoding ladder. For instance, in some embodiments, the overall objective 240 is to reduce the total size of downloadables generated when encoding the representative video 102 based on the encoding ladder 142 while ensuring that requisite visual quality can be achieved and accounting for the primary ladder criteria 150 and the fallback criteria 152. In some other embodiments, the overall objective 240 is to reduce the total size of downloadables generated when encoding the representative video 102 based on the encoding ladder 142 while increasing an overall visual quality associated with the encoding ladder 142 and satisfying the primary ladder criteria 150 and the fallback criteria 152.

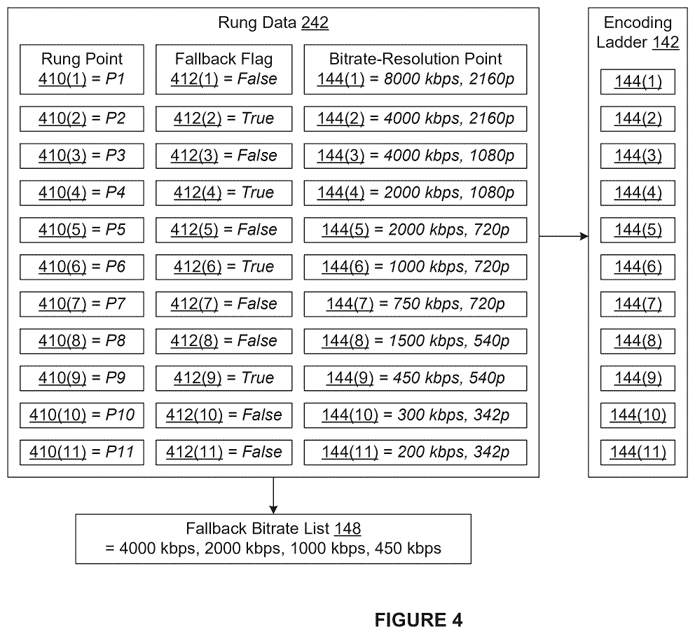

The ladder generator 140 generates the rung data 242 based on the convex hulls 210, the primary ladder criteria 150, the fallback criteria 152, and the overall objective 240. As described in greater detail below in conjunction with FIG. 4, the rung data 242 includes, without limitation, N rung points, the bitrate-resolution points 144, and N fallback flags. As described previously herein, the ladder generator 140 aggregates the bitrate-resolution points 144 to generate the encoding ladder 142, N is an integer that is equal to the total number of rungs of the encoding ladder 142 and therefore the total number of bitrate-resolution points 144

The rung points specify a subset of the bitrate-quality points included in the convex hulls 210 that are to be represented in the encoding ladder by corresponding bitrate-resolution points (i.e., the bitrate-resolution points 144). Each bitrate-resolution point 144 includes the bitrate and the resolution of a corresponding rung point but include neither the encoded video nor the quality score of the corresponding rung point. For explanatory purposes, a rung point that corresponds to a shadow bitrate-resolution point is also referred to herein as a “shadow rung point,” and a rung point that corresponds to a fallback bitrate-resolution point is also referred to herein as a “fallback rung point.” The fallback flags indicate which of the rung points are fallback rung points and therefore which of the bitrate-resolution points are fallback bitrate-resolution points.

The ladder generator 140 can implement any number and/or types of techniques to generate the rung data 242 based on the convex hull set 136, the primary ladder criteria 150, the fallback criteria 152, and the overall objective 240. For instance, in some embodiments, the ladder generator 140 formulates the problem of generating the rung data 242 as a constrained optimization problem. The ladder generator 140 then implements any number and/or types of techniques to solve the constrained optimization problem. As persons skilled in the art will recognize, a “constrained optimization problem” is a problem for which the goal is to minimize or maximize an objective function with respect to one or more variables subject to any number and/or types of constraints on the variables. In some embodiments, the variables are the bitrate-quality points from the convex hull set 136 that are designated as rung points, the values of associated fallback flags, and optionally the total number of rung points. The constraints are the primary ladder criteria 150 and the fallback criteria 152. The objective function reflects the overall objective 240. Constrained optimization, constrained optimization problems, techniques for solving constrained optimization problems, and constrained optimization algorithms are well-known in the art. Some examples of techniques for solving constrained optimization problems include, without limitation, linear programming, Lagrangian methods, projected gradient descent methods, branch-and-bound algorithms, the Simplex algorithm, genetic algorithms, simulated annealing, penalty methods, and substitution methods. The use of any of these techniques or any other similar optimization technique falls within the scope of the inventive concepts described herein.

As shown, the ladder generator 140 generates the encoding ladder 142 and the fallback bitrate list 148 based on the rung data 242. Importantly, the ladder generator 140 constructs the encoding ladder 142 based on the fallback bitrate-resolution points and the other bitrate-resolution points specified in the fallback bitrate list 148. As shown, the encoding ladder 142 includes, without limitation, the bitrate-resolution point 144(1)-the bitrate-resolution point 144(N). Notably, at least one of the bitrate-resolution points 144 is a fallback bitrate-resolution point. Advantageously, each fallback bitrate-resolution point provides an opportunity to adaptively reduce the amount of network and/or CDN processing resources required when streaming the live event without unacceptably and/or unnecessarily degrading overall visual quality for the client devices 190.

The ladder generator 140 generates the fallback bitrate list 148 based on the subset of the bitrate-resolution points 144 included in the rung data 242 that are designated as fallback bitrate-resolution points via the associated fallback flags. The fallback bitrate list 148 includes, without limitation, a different bitrate for each of the fallback bitrate-resolution points. More specifically, in some embodiments, the fallback bitrate list 148 includes the bitrates of the fallback bitrate-resolution points. In some other embodiments, the fallback bitrate list 148 includes bitrates that are slightly higher than the bitrates of the fallback bitrate-resolution points.

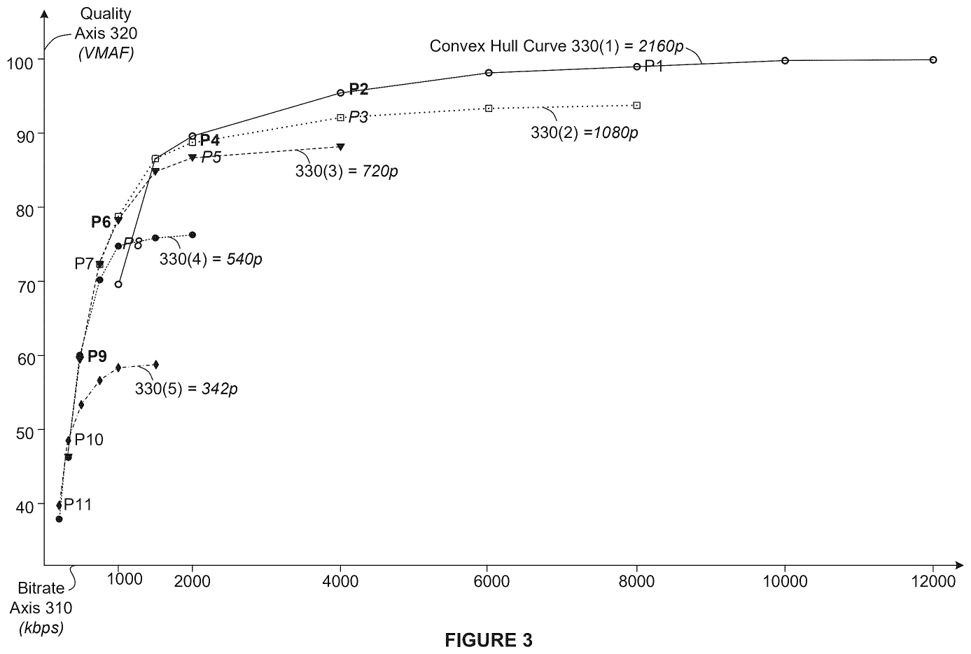

FIG. 3 is an exemplar illustration of multiple different convex hull curves corresponding to the convex hull set 136 of FIG. 2, according to various embodiments. For explanatory purposes only, in the embodiment depicted in FIGS. 3 and 4, the number of resolutions (M) is five and therefore the convex hull set 136 includes the convex hull 210(1)—the convex hull 210(5). The convex hull 210(1)—the convex hull 210(5) correspond, respectively, to the resolutions 2160p, 1080p, 720p, 540p, and 342p. In some other embodiments, the number of resolutions (and therefore the number of convex hulls 210) and the resolutions can vary.

FIG. 3 graphically depicts a subset of the bitrate-quality points included in exemplar versions of the convex hull 210(1)—the convex hull 210(5) as plotted along a bitrate axis 310 and a quality axis 320. More specifically, for each of the bitrate-quality points included in the exemplar versions of the convex hull 210(1)—the convex hull 210(5), the bitrate is depicted along the bitrate axis 310 and the quality score is depicted along the quality axis 320. As depicted in italics, bitrates located along the bitrate axis 210 are specified in kbps, and quality scores located along the quality axis 330 are values of a VMAF metric. For explanatory purposes, the depicted subsets of the bitrate-quality points included in the convex hull 210(1)—the convex hull 210(5) are denoted, respectively, via unfilled circles, unfilled squares, filled triangles, filled circles, and filled diamonds.

As shown, a convex hull curve 330(1)—a convex hull curve 330(5) depict the overall shape defined by the bitrate-quality points included in the exemplar versions of the convex hull 210(1)—the convex hull 210(5), respectively. For explanatory purposes, the convex hull curve 330(1)—the convex hull curve 330(5) are denoted, respectively, via a solid line, a dotted line, a long-dashed line, a short-dashed line, and a dash-dotted line.

Although not shown, the ladder generator 140 computes saturation quality scores for the resolutions 2160p, 1080p, 720p, 540p, and 342p, respectively, based on the convex hull 210(1)—the convex hull 210(5), respectively. The shapes of the convex hull curve 330(1)—the convex hull curve 330(5) illustrate saturation quality scores of approximately 100, 94, 88, 77, and 59, respectively.

As described previously herein in conjunction with FIG. 2, the ladder generator 140 designates a subset of the bitrate-quality points from the convex hulls 210 as rung points. Each rung point corresponds to a different bitrate-resolution point that is to be included in the encoding ladder 142. The ladder generator 140 also designates any number of rung points as fallback rung points and the corresponding bitrate-resolution points as fallback bitrate-resolution points, respectively, via associated fallback flags. In some embodiments, to designate a rung point as a fallback rung point and the corresponding fallback bitrate-resolution point as a fallback bitrate-resolution point, the ladder generator 140 sets a corresponding fallback flag to true. Otherwise, the ladder generator 140 sets the corresponding fallback flag to false.

The ladder generator 140 selects eleven of the bitrate-quality points from the convex hulls 210 as rung points that are denoted P1-P11. As illustrated by the convex hull curve 330(1)—the convex hull curve 330(4), the rung points P3, P5, and P8 are sub-optimal run points and therefore are shadow rung points. For explanatory purposes the ladder generator 140 designates the rung points P2, P4, P6, and P9 as shadow rung points. The shadow rung points P3, P5, and P8 are depicted in a non-bold italic font, the fallback rung points P2, P4, P6, P9 are denoted in a bold non-italic font, and the remaining rung points P1, P7, P10, and P11 are denoted in a non-bold non-italic font.

As described previously herein in conjunction with FIG. 2, the ladder generator 140 computes the fallback rung points and therefore the fallback bitrate-resolution points based, at least in part, on the fallback criteria 152. Referring back now to FIG. 2, in some embodiments (including the embodiments depicted in FIG. 3), the fallback criteria 152 include the fallback criterion 250(1)—the fallback criterion 250(4). Accordingly, the fallback rung points P2, P4, P6, P9 reflect the fallback criterion 250(1)—the fallback criterion 250(4).

As shown, the fallback rung point P2 corresponds to a resolution of 2160p, a bitrate of 4000 kbps, and a quality score of 96. The fallback rung point P4 corresponds to a resolution of 1080p, a bitrate of 2000 kbps, and a quality score of 89. The fallback rung point P6 corresponds to a resolution of 720p, a bitrate of 1000 kbps, and a quality score of 78. The fallback rung point P9 corresponds to a resolution of 540p, a bitrate of 450 kbps, and a quality score of 60.

The fallback criterion 250(1) prohibits the use of a sub-optimal bitrate-resolution point as a fallback bitrate-resolution point. In accordance with the fallback criterion 250(1), none of the shadow rung points (P3, P5, and P8) are designated as fallback rung points.

For explanatory purposes, the fallback criterion 250(2) requires that at least one fallback bitrate-resolution point is computed for each of the resolutions 2160p, 1080p, 720p, and 540p. In accordance with the fallback criterion 250(2), the fallback rung points P2, P4, P6, and P9 correspond, respectively, to the resolutions 2160p, 1080p, 720p, and 540p.

The fallback criterion 250(3) is a preference to select, for each required resolution, a fallback bitrate-resolution point having a quality score that is higher and relatively close to the saturation quality score of the next lower resolution represented by the convex hull set 136. In accordance with the fallback criterion 250(3), the fallback rung point P2 corresponds to a resolution of 2160p and a quality score of 96 that is higher and relatively close to the saturation quality score for 1080p of 94. The fallback rung point P4 corresponds to a resolution of 1080p and a quality score of 89 that is higher and relatively close to the saturation quality score for 720p of 88. The fallback rung point P6 corresponds to a resolution of 720p and a quality score of 89 that is higher and relatively close to the saturation quality score for 540p of 88. The fallback rung point P9 corresponds to a resolution of 520p and a quality score of 60 that is higher and relatively close to the saturation quality score for 342p of 59.

The fallback criterion 250(4) is preference to select fallback bitrate-resolution points that achieve a bitrate reduction that is within a specified range of either another fallback bitrate-resolution point or a highest bitrate that is represented by the encoding ladder 142. As used herein, the highest bitrate that is represented by the encoding ladder 142 is the highest of the bitrates specified by the bitrate-resolution points included in the encoding ladder 142. For explanatory purposes, the specified range is 40% to 60%.

As shown, with respect to the rung point P1-P11, the rung point P1 corresponds to the highest bitrate of 8000 kbps and therefore 8000 kbps is the highest bitrate that is represented by the encoding ladder 142 is 8000 kbps. In accordance with the fallback criterion 250(4), the fallback rung point P2 corresponds to a bitrate of 4000 kbps and therefore represents a 50% bitrate reduction relative to the highest bitrate that is represented by the encoding ladder 142. The fallback rung point P4 corresponds to a bitrate of 2000 kbps and therefore represents a 50% bitrate reduction relative to the fallback rung point P2. The fallback rung point P6 corresponds to a bitrate of 1000 kbps and therefore represents a 50% bitrate reduction relative to the fallback rung point P4. The fallback rung point P9 corresponds to a bitrate of 450 kbps and therefore represents a 55% bitrate reduction relative to the fallback rung point P6. The overall bitrate reductions represented by the fallback rung points P2, P4, P6, and P9 (and therefore the corresponding fallback bitrate-resolution points) relative highest bitrate that is represented by the encoding ladder 142 are therefore 50%, 75%, 87.5%, and 94.375%, respectively.

FIG. 4 is an exemplar illustration of the rung data 242, the encoding ladder 142, and the fallback bitrate list 148 generated by the ladder generator 140 of FIG. 2, according to various embodiments. For explanatory purposes, the ladder generator 140 generates the rung data 242 based on the exemplar version of the convex hull set 136 depicted graphically previously herein in FIG. 3 via the convex hull curve 330(1)—the convex hull curve 330(5), respectively.

As shown, the rung data 242 includes, without limitation, a rung point 410(1)—a rung point 410(11), a fallback flag 412(1)—a fallback flag 412(11), and the bitrate-resolution point 144(1)—the bitrate-resolution point 144(11). Each of the rung point 410(1)—the rung point 410(11) is a different bitrate-quality point included in the exemplar version of the convex hull set 136. As noted in italics, the rung point 410(1) the rung point 410(11) are equal to the bitrate-quality points depicted graphically as P1-P11, respectively, in FIG. 4.

As shown, the rung point 410(1) corresponds to the bitrate-resolution point 144(1) having a bitrate of 8000 kbps and a resolution of 2160p. The fallback flag 412(1) is false, indicating that the bitrate-resolution point 144(1) is not a fallback bitrate-resolution point. The rung point 410(2) corresponds to the bitrate-resolution point 144(2) having a bitrate of 4000 kbps and a resolution of 2160p. The fallback flag 412(2) is true, indicating that the bitrate-resolution point 144(2) is a fallback bitrate-resolution point.

As shown, the rung point 410(3) corresponds to the bitrate-resolution point 144(3) having a bitrate of 4000 kbps and a resolution of 1080p. The fallback flag 412(3) is false, indicating that the bitrate-resolution point 144(3) is not a fallback bitrate-resolution point. The rung point 410(4) corresponds to the bitrate-resolution point 144(4) having a bitrate of 2000 kbps and a resolution of 1080p. The fallback flag 412(4) is true, indicating that the bitrate-resolution point 144(4) is a fallback bitrate-resolution point.

As shown, the rung point 410(5) corresponds to the bitrate-resolution point 144(5) having a bitrate of 2000 kbps and a resolution of 720p. The fallback flag 412(5) is false, indicating that the bitrate-resolution point 144(5) is not a fallback bitrate-resolution point. The rung point 410(6) corresponds to the bitrate-resolution point 144(6) having a bitrate of 1000 kbps and a resolution of 720p. The fallback flag 412(6) is true, indicating that the bitrate-resolution point 144(6) is a fallback bitrate-resolution point. As shown, the rung point 410(7) corresponds to the bitrate-resolution point 144(7) having a bitrate of 750 kbps and a resolution of 720p. The fallback flag 412(7) is false, indicating that the bitrate-resolution point 144(7) is not a fallback bitrate-resolution point.

As shown, the rung point 410(8) corresponds to the bitrate-resolution point 144(8) having a bitrate of 1500 kbps and a resolution of 540p. The fallback flag 412(8) is false, indicating that the bitrate-resolution point 144(8) is not a fallback bitrate-resolution point. The rung point 410(9) corresponds to the bitrate-resolution point 144(9) having a bitrate of 450 kbps and a resolution of 540p. The fallback flag 412(9) is true, indicating that the bitrate-resolution point 144(9) is a fallback bitrate-resolution point.

As shown, the rung point 410(10) corresponds to the bitrate-resolution point 144(10) having a bitrate of 300 kbps and a resolution of 342p. The fallback flag 412(10) is false, indicating that the bitrate-resolution point 144(10) is not a fallback bitrate-resolution point. As shown, the rung point 410(11) corresponds to the bitrate-resolution point 144(11) having a bitrate of 200 kbps and a resolution of 342p. The fallback flag 412(11) is false, indicating that the bitrate-resolution point 144(11) is not a fallback bitrate-resolution point.

As shown, the encoding ladder 142 includes, without limitation, the bitrate-resolution point 144(1)—the bitrate-resolution point 144(11). The fallback bitrate list 148 includes, without limitation, the bitrates 4000 kbps, 2000 kbps, 1000 kbps, and 450 kbps that correspond to the bitrate-resolution point 144(2), the bitrate-resolution point 144(4), the bitrate-resolution point 144(6), and the bitrate-resolution point 144(9) as per the rung data 242, where the bitrate-resolution point 144(2), the bitrate-resolution point 144(4), the bitrate-resolution point 144(6), and the bitrate-resolution point 144(9) are fallback bitrate-resolution points.

Notably, the bitrate 8000 kbps is the highest bitrate represented in the encoding ladder 142. The overall bitrate reductions represented by the fallback bitrate-resolution point 144(2), the fallback bitrate-resolution point 144(4), the fallback bitrate-resolution point 144(6), and the fallback bitrate-resolution point 144(9) relative to the highest bitrate represented in the encoding ladder 142 are therefore 50%, 75%, 87.5%, and 94.375%, respectively.

Referring back now to FIG. 4, the fallback bitrate-resolution point 144(1) the fallback bitrate-resolution point 144(4), the fallback bitrate-resolution point 144(6), and the fallback bitrate-resolution point 144(9) are associated with quality scores of 96, 89, 78, and 60, respectively. Advantageously, as illustrated by the fallback bitrate list 148 and the associated quality scores, the disclosed techniques provide multiple opportunities to adaptively reduce the amount of network and/or CDN processing resources required when streaming the live event without unnecessarily and/or unacceptably degrading overall visual quality for many client devices.

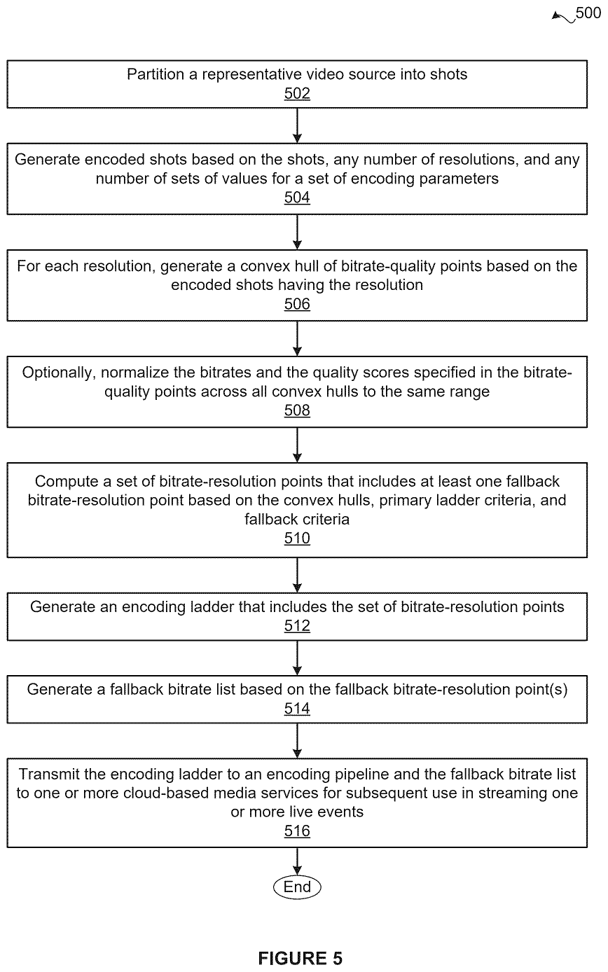

FIG. 5 is a flow diagram of method steps for generating an encoding ladder and fallback bitrate list for use when streaming one or more live events, according to various embodiments. Although the method steps are described with reference to the systems of FIGS. 1-4, persons skilled in the art will understand that any system configured to implement the method steps, in any order, falls within the scope of the embodiments.

As shown, a method 500 begins at step 502, where the shot-based encoding engine 130 partitions a representative video into shots. At step 504, the shot-based encoding engine 130 generates encoded shots based on the shots, any number of resolutions, and any number of sets of values for a set of encoding parameters.

At step 506, for each resolution, the shot-based encoding engine generates a convex hull of bitrate-quality points based on the encoded shots having the resolution. At step 508, the shot-based encoding engine optionally normalizes the bitrates and the quality scores specified in the bitrate-quality points across all convex hulls to the same range.

At step 510, the ladder generator 140 computes a set of bitrate-resolution points that includes at least one fallback bitrate-resolution point based on the convex hulls, primary ladder criteria 150 and fallback criteria 152, designating at least one bitrate-quality point as a fallback bitrate-resolution point. At step 512, the ladder generator 140 generates encoding ladder 142 that includes the set of bitrate-resolution points. At step 514, the ladder generator 140, generates fallback bitrate list 148 based on the fallback bitrate-resolution point(s).

At step 516, the ladder generator 140 transmits the encoding ladder 142 to an encoding pipeline and the fallback bitrate list 148 to any number of cloud-based media services for subsequent use in streaming one or more live events. The method 500 then terminates.

Importantly, as described previously herein, the same encoding ladder can be used to encode any number of live video feeds during each of any number of live events to generate any number of downloadables. And the same fallback bitrate list can be used to reduce network and/or CDN processing resources associated with streaming any number of downloadables and/or any number of live events.

In sum, the disclosed techniques can be used to generate an encoding ladder that provides opportunities to adaptively reduce the amount of required network and/or CDN processing resources while streaming a live event in a visually effective manner. In some embodiments, an encoding ladder application includes a shot-based encoding engine, a ladder generator, primary ladder criteria, and fallback criteria. The shot-based encoding engine partitions a representative video having characteristics similar to a live event feed associated with the live event into different shots. The shot-based encoding engine encodes each shot across a set of resolutions and multiple different encoding parameter sets to generate encoded shots. For each resolution, the shot-based encoding engine generates a convex hull of bitrate-quality points based on the encoded shots corresponding to the resolution. Each convex hull optimizes tradeoffs between bitrate and quality score for the resolution. Each of the bitrate-quality points specifies a different encoded video and the corresponding resolution, bitrate, and quality score. Notably, the resolution across each of the encoded videos is constant, but the bitrate and quality score can vary. The shot-based encoding engine optionally normalizes the bitrates and the quality scores specified in the bitrate-quality points across all convex hulls to the same range.

The ladder generator generates rung data based on the convex hulls, any number of primary ladder criteria, and any number of fallback criteria in order to achieve an overall objective. The rung data includes any N rung points, N bitrate-resolution points, and N fallback flags, where N can be any positive integer. The rung points specify a subset of the bitrate-quality points included in the convex hulls that are to be represented in the encoding ladder by the corresponding bitrate-resolution points. The fallback flags indicate whether the corresponding bitrate-resolution points are fallback bitrate-resolution points. A fallback bitrate-resolution point is a bitrate-resolution point that is intended as a fallback to one or bitrate-resolution points included in the encoding ladder that are prohibited when a corresponding maximum bitrate is imposed.

The overall objective is to reduce the total size of downloadables generated based on the encoding ladder while ensuring that requisite visual quality can be achieved and accounting for the primary ladder criteria and the fallback criteria. The primary ladder criteria ensure the validity of the encoding ladder and capture operational restrictions and/or preferences that are associated with capabilities of client devices, network capacity, a CDN, human perception of visual quality, etc. For example, a bitrate spacing criteria ensures that the bitrates of the bitrate-resolution points included in the encoding ladder are separated by no more than a relative bitrate spacing.

The fallback criteria ensure that the encoding ladder includes one or more effective fallback bitrate-resolution points. The fallback criteria include a shadow point prohibition, a fallback per resolution requirement, a quality saturation fit preference, and a bitrate reduction preference. The shadow point prohibition prohibits the use of a sub-optimal bitrate-resolution point (e.g., a shadow bitrate-resolution point) as a fallback bitrate-resolution point. The fallback resolution requirement specifies that the encoding ladder is to include at least one fallback resolution-bitrate point for each resolution included in a subset of the set of resolutions used to generate the convex hulls. The quality saturation fit preference is an optionally weighted preference for each non-lowest resolution to select a fallback bitrate-resolution point corresponding to a quality score that is higher and relatively close to the saturation quality score of the next lower resolution. The bitrate reduction preference is an optionally weighted preference to select fallback bitrate-resolution points that achieve a bitrate reduction that is within a specified range (e.g., 40%-60%) of either another fallback bitrate-resolution point or a highest bitrate represented by the rung data. As persons skilled in the art will recognize, weights can be selected to quantify a tradeoff between the optionally weighted quality saturation fit preference and the optionally weighted bitrate reduction preference.

The ladder generator generates an encoding ladder and a fallback bitrate list based on the rung data. The encoding ladder includes the bitrate-resolution points specified in the rung data. The fallback bitrate list specifies the bitrate of each of the fallback bitrate-resolution points specified in the rung data. The ladder generator transmits the encoding ladder to an encoding pipeline that incrementally generates segments of downloadables based on one or more live event feeds associated with the live event in real-time and transmits the segments to a CDN for on-demand delivery to client devices. The ladder generator transmits the fallback bitrate list to cloud-based media services. During the live event, the cloud-based media services can set a maximum bitrate equal to a bitrate specified in the fallback list in order to reduce at least one of processing resources or network resources used to stream the live event to any number of client devices via the CDN.

At least one technical advantage of the disclosed techniques relative to the prior art is that, with the disclosed techniques, any number of fallback resolution-bitrate points can be identified and included in a given encoding ladder when generating the encoding ladder, in the first instance, prior to a live event. With this type of modified encoding ladder, imposing a maximum bitrate during the live event that is no less that the bitrate specified in a given fallback resolution-bitrate point ensures that client devices capable of streaming the live event at the resolution specified in the fallback resolution-bitrate point can achieve the overall visual quality associated with the fallback resolution-bitrate point. Thus, the disclosed techniques enable certain client devices to operate at fallback resolution-bitrate points while streaming a live event, which provides opportunities to adaptively reduce the amount of network and/or CDN processing resources required when streaming the live event without unacceptably degrading overall visual quality for those client devices. These technical advantages provide one or more technological improvements over prior art approaches.
1. In some embodiments, a computer-implemented method for generating encoding ladders that are subsequently used to stream live events comprises generating a plurality of convex hulls representing encoding tradeoffs between quality and bitrate when encoding a representative video at a plurality of resolutions; computing a first plurality of bitrate-resolution points to use as fallback bitrate-resolution points using the plurality of convex hulls and a set of fallback criteria; generating an encoding ladder that includes the fallback bitrate-resolution points; and encoding at least a first portion of a first live video stream based on a first fallback bitrate-resolution point included in the fallback bitrate-resolution points to produce a first segment of a first downloadable.
2. The computer-implemented method of clause 1, further comprising generating a fallback bitrate list based on the fallback bitrate-resolution points, wherein one or more additional segments of the first downloadable are transmitted to a client device based on the fallback bitrate list.
3. The computer-implemented method of clauses 1 or 2, further comprising encoding at least a second portion of a second live video feed based on the first fallback bitrate-resolution point to produce a second segment of a second downloadable.
4. The computer-implemented method of any of clauses 1-3, wherein computing the first plurality of bitrate-resolution points comprises computing a first saturation quality score based on a first convex hull that is included in the plurality of convex hulls; and determining the first fallback bitrate-resolution point based on the first saturation quality score, a second convex hull that is included in the plurality of convex hulls, and a first fallback criterion included in the set of fallback criteria.
5. The computer-implemented method of any of clauses 1-4, wherein computing the first plurality of bitrate-resolution points comprises determining a second fallback bitrate-resolution point included in the first plurality of bitrate-resolution points based on a first bitrate associated with the first fallback bitrate-resolution point and a bitrate reduction range specified via a first fallback criterion included in the set of fallback criteria.
6. The computer-implemented method of any of clauses 1-5, wherein a first fallback criterion included in the set of fallback criteria prohibits the use of a sub-optimal bitrate-resolution point as a fallback bitrate-resolution point.
7. The computer-implemented method of any of clauses 1-6, wherein a first fallback criterion included in the set of fallback criteria requires that at least one fallback bitrate-resolution point is computed for each resolution included in a subset of the plurality of resolutions.
8. The computer-implemented method of any of clauses 1-7, generating the plurality of convex hulls comprises: encoding each shot included in the representative video at a first resolution included in the plurality of resolutions and across a plurality of encoding parameter sets to generate a plurality of encoded shots; generating a plurality of encoded videos based on the plurality of encoded shots and a visual quality metric; and computing a plurality of bitrate-quality points based on the plurality of encoded videos; and aggregating the plurality of bitrate-quality points to generate a first convex hull included in the plurality of convex hulls.
9. The computer-implemented method of any of clauses 1-8, wherein generating the encoding ladder comprises computing a second plurality of bitrate-resolution points using the plurality of convex hulls and at least one of a minimum allowed bitrate, a maximum allowed bitrate, a target bitrate spacing, a minimum quality score, or a mandatory resolution; and constructing the encoding ladder based on the fallback bitrate-resolution points and the second plurality of bitrate-resolution points.
10. The computer-implemented method of any of clauses 1-9, wherein the first plurality of bitrate-resolution points are further computed based on at least one of a minimum allowed bitrate, a maximum allowed bitrate, a target bitrate spacing, a minimum quality score, or a mandatory resolution.
11. In some embodiments, one or more non-transitory computer readable media include instructions that, when executed by one or more processors, cause the one or more processors to generate encoding ladders that are subsequently used to stream live events by performing the steps of generating a plurality of convex hulls representing encoding tradeoffs between quality and bitrate when encoding a representative video at a plurality of resolutions; computing a first plurality of bitrate-resolution points to use as fallback bitrate-resolution points using the plurality of convex hulls and a set of fallback criteria; generating an encoding ladder that includes the fallback bitrate-resolution points; and encoding at least a first portion of a first live video stream based on a first fallback bitrate-resolution point included in the fallback bitrate-resolution points to produce a first segment of a first downloadable.
12. The one or more non-transitory computer readable media of clause 11, further comprising generating a fallback bitrate list based on the fallback bitrate-resolution points; determining that a maximum bitrate should be imposed on a plurality of client devices based on an amount of network traffic present while streaming a live event during a first interval of time; and determining the maximum bitrate based on the fallback bitrate list.
13. The one or more non-transitory computer readable media of clauses 11 or 12, wherein the first downloadable is associated with a live event, and further comprising transmitting the first segment of the first downloadable to a plurality of client devices during the live event via a content delivery network.
14. The one or more non-transitory computer readable media of any of clauses 11-13, wherein computing the first plurality of bitrate-resolution points comprises computing a first saturation quality score based on a first convex hull that is included in the plurality of convex hulls; and determining the first fallback bitrate-resolution point based on the first saturation quality score, a second convex hull that is included in the plurality of convex hulls, and a first fallback criterion included in the set of fallback criteria.
15. The one or more non-transitory computer readable media of any of clauses 11-14, wherein computing the first plurality of bitrate-resolution points comprises determining a second fallback bitrate-resolution point included in the first plurality of bitrate-resolution points based on a first bitrate associated with the first fallback bitrate-resolution point and a bitrate reduction range specified via a first fallback criterion included in the set of fallback criteria.
16. The one or more non-transitory computer readable media of any of clauses 11-15, wherein a first fallback criterion included in the set of fallback criteria prohibits the use of a sub-optimal bitrate-resolution point as a fallback bitrate-resolution point.
17. The one or more non-transitory computer readable media of any of clauses 11-16, wherein a first fallback criterion included in the set of fallback criteria requires that at least one fallback bitrate-resolution point is computed for each resolution included in a subset of the plurality of resolutions.
18. The one or more non-transitory computer readable media of any of clauses 11-17, wherein generating the plurality of convex hulls comprises encoding each shot included in the representative video at a first resolution included in the plurality of resolutions and across a plurality of encoding parameter sets to generate a plurality of encoded shots; generating a plurality of encoded videos based on the plurality of encoded shots and a video multimethod assessment fusion metric that estimates perceptual video quality; computing a plurality of bitrate-quality points based on the plurality of encoded videos; and aggregating the plurality of bitrate-quality points to generate a first convex hull included in the plurality of convex hulls.
19. The one or more non-transitory computer readable media of any of clauses 11-18, wherein generating the encoding ladder comprises computing a second plurality of bitrate-resolution points using the plurality of convex hulls and at least one of a minimum allowed bitrate, a maximum allowed bitrate, a target bitrate spacing, a minimum quality score, or a mandatory resolution; and constructing the encoding ladder based on the fallback bitrate-resolution points and the second plurality of bitrate-resolution points.
20. In some embodiments, a system comprises one or more memories storing instructions and one or more processors coupled to the one or more memories that, when executing the instructions, perform the steps of generating a plurality of convex hulls representing encoding tradeoffs between quality and bitrate when encoding a representative video at a plurality of resolutions; computing a first plurality of bitrate-resolution points to use as fallback bitrate-resolution points using the plurality of convex hulls and a set of fallback criteria; generating an encoding ladder that includes the fallback bitrate-resolution points; and encoding at least a first portion of a first live video stream based on a first fallback bitrate-resolution point included in the fallback bitrate-resolution points to produce a first segment of a first downloadable.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating encoding ladders that are subsequently used to stream live events, the method comprising:
generating a plurality of convex hulls representing encoding tradeoffs between quality and bitrate when encoding a representative video at a plurality of resolutions;
computing a first plurality of bitrate-resolution points to use as fallback bitrate-resolution points using the plurality of convex hulls and a set of fallback criteria;
generating an encoding ladder that includes the fallback bitrate-resolution points; and
encoding at least a first portion of a first live video stream based on a first fallback bitrate-resolution point included in the fallback bitrate-resolution points to produce a first segment of a first downloadable.

2. The computer-implemented method of claim 1, further comprising generating a fallback bitrate list based on the fallback bitrate-resolution points, wherein one or more additional segments of the first downloadable are transmitted to a client device based on the fallback bitrate list.

3. The computer-implemented method of claim 1, further comprising encoding at least a second portion of a second live video feed based on the first fallback bitrate-resolution point to produce a second segment of a second downloadable.

4. The computer-implemented method of claim 1, wherein computing the first plurality of bitrate-resolution points comprises:
computing a first saturation quality score based on a first convex hull that is included in the plurality of convex hulls; and
determining the first fallback bitrate-resolution point based on the first saturation quality score, a second convex hull that is included in the plurality of convex hulls, and a first fallback criterion included in the set of fallback criteria.

5. The computer-implemented method of claim 1, wherein computing the first plurality of bitrate-resolution points comprises determining a second fallback bitrate-resolution point included in the first plurality of bitrate-resolution points based on a first bitrate associated with the first fallback bitrate-resolution point and a bitrate reduction range specified via a first fallback criterion included in the set of fallback criteria.

6. The computer-implemented method of claim 1, wherein a first fallback criterion included in the set of fallback criteria prohibits the use of a sub-optimal bitrate-resolution point as a fallback bitrate-resolution point.

7. The computer-implemented method of claim 1, wherein a first fallback criterion included in the set of fallback criteria requires that at least one fallback bitrate-resolution point is computed for each resolution included in a subset of the plurality of resolutions.

8. The computer-implemented method of claim 1, wherein generating the plurality of convex hulls comprises:
encoding each shot included in the representative video at a first resolution included in the plurality of resolutions and across a plurality of encoding parameter sets to generate a plurality of encoded shots;
generating a plurality of encoded videos based on the plurality of encoded shots and a visual quality metric;
computing a plurality of bitrate-quality points based on the plurality of encoded videos; and
aggregating the plurality of bitrate-quality points to generate a first convex hull included in the plurality of convex hulls.

9. The computer-implemented method of claim 1, wherein generating the encoding ladder comprises:
computing a second plurality of bitrate-resolution points using the plurality of convex hulls and at least one of a minimum allowed bitrate, a maximum allowed bitrate, a target bitrate spacing, a minimum quality score, or a mandatory resolution; and
constructing the encoding ladder based on the fallback bitrate-resolution points and the second plurality of bitrate-resolution points.

10. The computer-implemented method of claim 1, wherein the first plurality of bitrate-resolution points are further computed based on at least one of a minimum allowed bitrate, a maximum allowed bitrate, a target bitrate spacing, a minimum quality score, or a mandatory resolution.

11. One or more non-transitory computer readable media including instructions that, when executed by one or more processors, cause the one or more processors to generate encoding ladders that are subsequently used to stream live events by performing the steps of:
generating a plurality of convex hulls representing encoding tradeoffs between quality and bitrate when encoding a representative video at a plurality of resolutions;
computing a first plurality of bitrate-resolution points to use as fallback bitrate-resolution points using the plurality of convex hulls and a set of fallback criteria;
generating an encoding ladder that includes the fallback bitrate-resolution points; and
encoding at least a first portion of a first live video stream based on a first fallback bitrate-resolution point included in the fallback bitrate-resolution points to produce a first segment of a first downloadable.

12. The one or more non-transitory computer readable media of claim 11, further comprising:
generating a fallback bitrate list based on the fallback bitrate-resolution points;
determining that a maximum bitrate should be imposed on a plurality of client devices based on an amount of network traffic present while streaming a live event during a first interval of time; and
determining the maximum bitrate based on the fallback bitrate list.

13. The one or more non-transitory computer readable media of claim 11, wherein the first downloadable is associated with a live event, and further comprising transmitting the first segment of the first downloadable to a plurality of client devices during the live event via a content delivery network.

14. The one or more non-transitory computer readable media of claim 11, wherein computing the first plurality of bitrate-resolution points comprises:
computing a first saturation quality score based on a first convex hull that is included in the plurality of convex hulls; and
determining the first fallback bitrate-resolution point based on the first saturation quality score, a second convex hull that is included in the plurality of convex hulls, and a first fallback criterion included in the set of fallback criteria.

15. The one or more non-transitory computer readable media of claim 11, wherein computing the first plurality of bitrate-resolution points comprises determining a second fallback bitrate-resolution point included in the first plurality of bitrate-resolution points based on a first bitrate associated with the first fallback bitrate-resolution point and a bitrate reduction range specified via a first fallback criterion included in the set of fallback criteria.

16. The one or more non-transitory computer readable media of claim 11, wherein a first fallback criterion included in the set of fallback criteria prohibits the use of a sub-optimal bitrate-resolution point as a fallback bitrate-resolution point.

17. The one or more non-transitory computer readable media of claim 11, wherein a first fallback criterion included in the set of fallback criteria requires that at least one fallback bitrate-resolution point is computed for each resolution included in a subset of the plurality of resolutions.

18. The one or more non-transitory computer readable media of claim 11, wherein generating the plurality of convex hulls comprises:
encoding each shot included in the representative video at a first resolution included in the plurality of resolutions and across a plurality of encoding parameter sets to generate a plurality of encoded shots;
generating a plurality of encoded videos based on the plurality of encoded shots and a video multimethod assessment fusion metric that estimates perceptual video quality;
computing a plurality of bitrate-quality points based on the plurality of encoded videos; and
aggregating the plurality of bitrate-quality points to generate a first convex hull included in the plurality of convex hulls.

19. The one or more non-transitory computer readable media of claim 11, wherein generating the encoding ladder comprises:
computing a second plurality of bitrate-resolution points using the plurality of convex hulls and at least one of a minimum allowed bitrate, a maximum allowed bitrate, a target bitrate spacing, a minimum quality score, or a mandatory resolution; and
constructing the encoding ladder based on the fallback bitrate-resolution points and the second plurality of bitrate-resolution points.

20. A system comprising:
one or more memories storing instructions; and
one or more processors coupled to the one or more memories that, when executing the instructions, perform the steps of:
generating a plurality of convex hulls representing encoding tradeoffs between quality and bitrate when encoding a representative video at a plurality of resolutions;
computing a first plurality of bitrate-resolution points to use as fallback bitrate-resolution points using the plurality of convex hulls and a set of fallback criteria;
generating an encoding ladder that includes the fallback bitrate-resolution points; and
encoding at least a first portion of a first live video stream based on a first fallback bitrate-resolution point included in the fallback bitrate-resolution points to produce a first segment of a first downloadable.
